(19) United States
(12) Patent Application Publication
(10) Pub. No.: US 2014/0029022 A1
(43) Pub. Date: Jan. 30, 2014

(54) PHOTO STATION

(71) Applicants: Clay Johnson, Cedar City, UT (US); Leslie Atkin Johnson, Cedar City, UT (US)

(72) Inventors: Clay Johnson, Cedar City, UT (US); Leslie Atkin Johnson, Cedar City, UT (US)

(21) Appl. No.: 13/951,199

(22) Filed: Jul. 25, 2013

Related U.S. Application Data
(60) Provisional application No. 61/675,602, filed on Jul. 25, 2012.

(51) Int. Cl. G06T 11/60; G06K 9/00

(52) U.S. Cl. CPC G06T 11/60; G06K 9/00241
USPC 358/1.2; 345/632; 382/118

(57) ABSTRACT

An apparatus, system, and method are disclosed for a photo station and background graphic. A station includes a printer, a processor, a memory, and a user interface. The processor and computer memory store code including a receiver module and an editing module. The receiver module is configured to receive digital media. The editing module is configured to size and shape the digital media to fit in a selected zone on a background graphic. The background graphic has a selected zone sized and shaped to fit the media such that the user can attach the media to the selected zone.

### CROSS-REFERENCE TO RELATED APPLICATIONS

This application claims priority to U.S. Provisional Application No. 61/675,602, filed Jul. 25, 2012, titled APPARATUS, SYSTEM, AND METHOD FOR PHOTO STATION AND BACKGROUND GRAPHIC, which is incorporated herein by reference in its entirety.

### FIELD

This disclosure relates to photography and more particularly relates to photo stations.

### BACKGROUND

Photography is of interest to a very wide audience and is highly personal and valuable. Many individuals take photographs of family, friends, and destinations as an integral part of vacations. Photographs provide a record by which individuals can remember the places they visit, the people they meet, and the activities they participate in. With the advent of digital photography, many people take hundreds or thousands of pictures on vacation, yet rarely view or use them again. Most people who print photos simply go to a drugstore or the like with a photo processing lab to get photos printed in standard sizes. Those photos often end up in a box, rarely to be viewed again.

Many resorts, cruises, and other vacation destinations have activity centers where guests or their children can participate in fun, creative activities. Many provide games for children to play that day at the center.

The subject matter claimed herein is not limited to embodiments that solve any disadvantages or that operate only in environments such as those described above. Rather, this background is only provided to illustrate one example technology area where some embodiments described herein may be practiced.

### SUMMARY

At least some aspects of the present disclosure describes an apparatus, system, and method that provides a fun, creative way for individuals to use photographs to create memorable records. Beneficially, such an apparatus, system, and method may be easily implemented by resorts, cruise ships, or other vacation destinations for guests to easily create photographic records on site. An apparatus, system, and method by which a resort or cruise activity centers could offer memorable, personalized craft projects and souvenirs for guests to create during their visit that results in a meaningful keepsake that would provide memories for years to come. Alternately or additionally, such an apparatus, system, and method may be easily implemented in any location. For example, such an apparatus, system, and method may be easily implemented at tourist destinations, shopping centers, local markets, and/or any other location where people may desire to create memorable record of photographs. In this manner, the present disclosure provides an apparatus, system, and method by which any business could offer memorable, personalized craft projects and souvenirs that may result in a meaningful or otherwise keepsake.

The present disclosure has been developed in response to the present state of the art, and in particular, in response to the problems and needs in the art that have not yet been fully solved by currently available photo stations. Accordingly, the present disclosure has been developed to provide an apparatus, system, and method for a photo station and background graphic that overcome many or all of the above-discussed shortcomings in the art and/or other shortcomings in the art.

The apparatus is provided with a plurality of modules configured to functionally execute the necessary steps of receiving and editing photos that correspond to a background graphic. These modules in the described embodiments include a receiver module and an editing module.

The apparatus, in one embodiment, includes a station which includes a printer, a processor, a memory, and a user interface. In one embodiment, the processor and computer memory store code including a receiver module and an editing module. In another embodiment, the receiver module is configured to receive digital media. In a further embodiment, the editing module is configured to size and shape the digital media to fit in a selected zone on a background graphic. In an additional embodiment, the background graphic includes a selected zone sized and shaped to fit the media so that the user can attach the media to the selected zone.

In one embodiment, the station includes an integrated camera. In a further embodiment, the station includes a memory card reader, an optical disc drive, a network interface card, a wireless communication radio, and/or a universal serial bus (“USB”) port. In an additional embodiment, the apparatus includes a network enabled camera in communication with the station. In another embodiment, the network enabled camera is configured to upload digital media to the station.

In one embodiment, the apparatus includes a photo service module configured to connect to and retrieve digital media from a digital photo sharing service. In another embodiment, the background graphic includes a companion project with one or more of additional background graphics. In an additional embodiment, the background graphic includes additional removably adhesive media. In a further embodiment, the background graphic includes multiple selected zones. In another embodiment, each zone is sized and shaped to fit a media so that the user can attach the media to the selected zone.

In one embodiment, the editing module is configured to size and shape multiple digital media. In another embodiment, each digital media is sized and shaped to fit in a unique selected zone on a background graphic.

In one embodiment, the apparatus includes a printing module. In a further embodiment, the printing module includes a postcard module configured to size, design, and print one or more digital media onto a postcard. In another embodiment, the printing module includes a passport module configured to print a booklet including one or more digital media. In an additional embodiment, the booklet includes pre-printed pages for exchanging information and/or checking in at one or more destinations.

In one embodiment, the printing module includes a scrapbook module configured to print a detailed photographic page comprising decorative elements. In a further embodiment, the photographic page is suitable for displaying and/or archiving images. In an additional embodiment, the printing module includes a photo module configured to print photographs of various sizes. In another embodiment, the printing module includes a sticker module configured to print multiple images on a single sheet. In a further embodiment, the single sheet is formed of a base sheet layer and an imaging sheet layer which are removably adhered together. In an additional embodiment, each of the multiple images are separately sized, shaped, and cut, and can be separately peeled off from the supporting base sheet layer.

In one embodiment, the apparatus includes a backup module configured to copy digital media to a removable medium. In another embodiment, the removable medium is a CD, a DVD, a BLU-RAY, a USB drive, a memory card, and/or an external hard disk drive.

In one embodiment, the station includes an upload module configured to connect and upload digital media to a web-accessible server, a digital photo sharing service, and/or a website. In another embodiment, the station includes a facial recognition module configured to display digital media to the user in response to performing facial recognition of an image of the user.

In one embodiment, the station includes a tablet, a laptop, a smartphone, or a television. In another embodiment, the apparatus includes one or more additional stations electronically connected such that each station is in communication with the first station. In a further embodiment, each additional station includes instructions for viewing digital media stored on the first station, transmitting digital media to the first station, and ordering digital media to be printed at the first station. In an additional embodiment, one or more additional stations include a tablet, a laptop, a smartphone, or a television.

A system of the present disclosure is also presented. In particular, the system, in one embodiment, includes a station including a printer, a processor, a memory, and a user interface. In another embodiment, the processor and computer memory store code including a receiver module and an editing module.

In one embodiment, the receiver module receives digital media. The editing module, in another embodiment, the editing module sizes and shapes the digital media to fit in a selected zone on a background graphic. In a further embodiment, the background graphic has a selected zone sized and shaped to fit the media such that the user can attach the media to the selected zone.

A method of the present disclosure is also presented. The method in the disclosed embodiments substantially includes the steps necessary to carry out the functions presented above with respect to the operation of the described apparatus and system. In one embodiment, the method includes receiving digital media. The method also may include sizing and shaping the digital media to fit in a selected zone on a background graphic. In one embodiment, the background graphic has a selected zone sized and shaped to fit the media so that the user can attach the media to the selected zone.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1 is a schematic block diagram illustrating one embodiment of a photo station and background graphic in accordance with the present disclosure;

FIG. 2 is a schematic block diagram illustrating an alternative embodiment in accordance with the present disclosure;

FIG. 3 is a schematic block diagram illustrating one embodiment in accordance with the present disclosure, with a network connecting multiple stations, a camera, and a photo sharing service;

FIG. 4 is a perspective view illustrating one embodiment in accordance with the present disclosure, with a kiosk;

FIG. 5 is a schematic block diagram illustrating one embodiment of a printing module in accordance with the present disclosure;

FIG. 6 is a flowchart diagram illustrating one embodiment of a method of the present disclosure;

FIG. 7 is a flowchart diagram illustrating one embodiment of a method for creating sticker craft activity project; and

FIG. 8 is a flowchart diagram illustrating one embodiment of the method steps of sizing and shaping the digital media.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

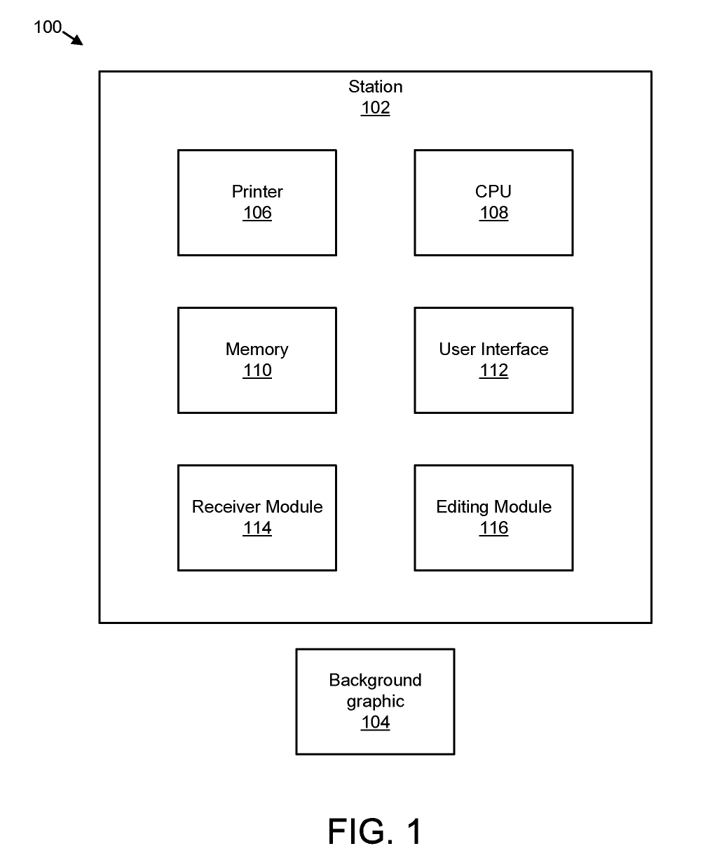

FIG. 1 depicts one embodiment of an apparatus in accordance with the present disclosure. The apparatus 100 includes a station 102 and a background graphic 104. The station 102 includes a printer 106, a processor 108, a memory 110, a user interface 112, a receiver module 114, and an editing module 116.

The station 102 could take many forms. In one embodiment, the station 102 could be contained within a kiosk. In other embodiments, the station 102 could be behind the counter of a hotel or resort check-in desk, at an activity station on a cruise ship, or contain various elements connected via a network or the internet. The station 102, in one embodiment, could include a computer. Another embodiment could include a tablet, a laptop, a smartphone, a television or the like.

The background graphic 104 includes at least one selected zone sized and shaped to fit the media that the user may attach to it. The background graphic 104 may be a card, a piece of paper, a postcard, a canvas, an article of clothing, a journal, a scrapbook page, a booklet, a poster, and the like. The background graphic 104 in one embodiment may include a scene. The scene may be one of any infinite number of scenes, which in one embodiment may include a beach, underwater, a forest, a jungle, a city, a farm, or another setting. A setting depicted on the background graphic 104 may include many details, such as in a photograph, or in other embodiments may be a simple illustration or drawing. In some embodiments, the background graphic 104 may be a photograph. The background graphic 104 need not be a scene, but instead may, in other embodiments, simply include white, black, one color, or many colors. The background graphic 104 may include words, logos, the name of a resort, the name of a cruise ship, the name of a tourist destination, or the like. The background graphic 104 may include one or more additional decorative elements.

The background graphic 104 includes at least one selected zone sized and shaped to fit a media. The selected zone sized and shaped to fit a media may include a dashed, dotted, or solid line outline of a shape. In another embodiment, the selected zone may be a dot, a circle, an “X”, or the like. In another embodiment, the selected zone may include no position indicator allowing the user to choose the location to attach media in the selected zone. The background graphic 104 may include one or multiple selected zones. In one embodiment, where there are multiple zones, the different zones may include different shapes, marks, or styles to indicate where a media should be placed. The selected zone is sized and shaped such that a user can attach a media to the selected zone.

The station 102 includes a printer 106. The printer 106, in various embodiments, may include an ink-jet printer, a laser-jet printer, a dye sublimation printer, or the like. The printer 106 may be wirelessly connected to the station 102, or the printer 106 may include a wired connection to the station 102. In one embodiment, the printer 106 is integrated into the station. The station may include a door, compartment, or other method by which to contain or enclose the printer 106. The printer 106, in another embodiment, may be discrete from the central station. The printer 106 could include duplexing capabilities. The printer may include a standard “off the shelf” printer. The printer 106, in one embodiment, is capable of printing on certified postcard stock.

The background graphic 104, in one embodiment, is pre-printed, and is not printed by the printer 106 associated with the station 102. In a further embodiment, the printer 106 is a large multi-function printing device, including multiple trays, where a different background, format, or template is printed from each tray.

The station 102 includes a processor 108. The processor 108 serves to functionally execute the code, instructions, or other functions of the various modules. The station 102 includes a memory 110. The memory 110 provides a readable and writeable area for files processed, created, read, and otherwise used by the processor 108 in connection with performing the functions of the station 102.

The station 102 includes a user interface 112. The user interface 112 may include a touchscreen, a mouse, a trackball, a keyboard, a fingerprint input device, voice recognition functionality, or another type of input device. The user interface 112 may display the different options available to be performed by the apparatus 100. In one embodiment, the user interface 112 may include a series of screens, each configured to display functionality to the user for selecting and executing options. The user interface 112 provides the functionality by which the user interacts with the various modules and functions of the station. The station, in various embodiments, includes different modules, as described below. In the various embodiments, the user interface 112 provides controls to the user by which to perform the actions described in connection with each of the various modules, as described below. For example, the user interface 112 may include functionality for editing and resizing images, displaying images, uploading images, printing images, and the other functionality provided by the plurality of modules.

The user interface 112 may include a graphical user interface, or simply interact with the user using text. The user interface 112 may include an app, an application, an operating system, a web page, a web server, a series of icons, a menu similar to a DVD menu, text prompts, or the like. The user interface may include a series of menus, each of which corresponds to a different function of the station 102. For example, there may be a screen for selecting media, a screen for editing media, a screen for printing media, and a screen for backing up media. The interface for each function provided by the station 102 may include more than one screen. Each screen may include menus, options, buttons, views, previews, or other elements known to those in the art. The functionality described in connection with each of the various modules below may include a part of the user interface 112 for the functionality corresponding to that particular module.

The station 102 includes a receiver module 114. The receiver module 114 is configured to receive digital media. The receiver module 114, in one embodiment, may provide the user with prompts for inputting digital images into the station 102. The receiver module 114 may be associated with a digital media input device, such as a camera, memory card reader, optical disc drive, network interface card, wireless communication radio, universal serial bus (“USB”) port, or the like. In one embodiment, digital media could include digital photographs, scans of photographic prints, scans of photographic negatives, illustrations, and the like.

The receiver module 114 may include a series of prompts for receiving input from a user. The receiver module 114 may provide prompts for selecting images. Images may be selected, in one embodiment, one at a time, multiple at a time, in a series, or all at once. Once selected, the images may be transferred to the station 102, where they are stored in the memory 110. In an alternative embodiment, the station 102 may use the images without transferring them first, working directly from the camera, memory card, disc, or other original location on which the image was provided to the receiver module 114.

The station includes an editing module 116. The editing module 116 is configured to size and shape the digital media to fit in a selected zone on a background graphic. The editing module 116 may, in one embodiment, include prompts that allow the user to select a graphic. After selecting a graphic, the user may stretch, shrink, or resize the image to fit within a displayed background. The editing module 116 may, in some embodiments, allow the user to insert the image into a predefined background, which may include various shapes, illustrations, other images, or the like. In one embodiment, the image is sized and shaped for a specific background. It is then placed inside of a foreground or a mask that matches the design of the background graphic 104 that the user is working on. According to one embodiment, each image that the user selects has a different shaped mask applied to it, with each mask including graphical elements that correspond to the particular background graphic 104 or project.

In another embodiment, the editing module 116 may include other options, including but not limited to inserting foreground images, combining images, flipping images, cropping out parts of one of the original, background, and foreground images, and the like. The background graphic 104 has at least one selected zone sized and shaped to fit the media, so that the user can attach the media to the selected zone.

For example, if the background graphic 104 is an image of an underwater scene, the editing module 116 may allow a user to shape, crop, and manipulate a digital image so that a face in the image is superimposed onto a mermaid's body. When printed, the mermaid with the face from the digital image may be affixed to a predefined space on the background graphic 104 that is marked with the outline of a mermaid, creating a memorable, personalized souvenir. In a further embodiment, the underwater scene may include other elements that can be printed and affixed to the underwater scene by the user, such as a treasure chest, other fish, or a diver. Of course, any scene may be used for the background graphic 104, and any image, theme, or personalized graphic may be created using the station 102.

The editing module 116, in one embodiment, includes an automation option to automatically populate, edit, size, and print project pages for a selected set of images or projects. The editing module 116 may simply require the user to select a project and one or more images. For example, the editing module 116 may detect the face in each picture, position the face to be within a mask or background image, and then print the completed media. This mode may prove useful, for example, in an activity center, where there are multiple participants, and where it may not be feasible for each participant to individually access and use the station to size and position images. The editing module 116 could size, position, and self-populate the face of each participant within the template, then print a sticker sheet for that participant. This would allow for one instructor to quickly and easily create personalized stickers or other media for use in an activity center project, without requiring the time for each user to go through the steps of manually editing, sizing, and positioning photos within a template. The editing module 116 automation mode may further include the option to automatically populate the template files, and then allow the user to go back and manually edit the results of the automatic placement. This would allow, for example, a user to quickly move through the editing process, yet still have custom results if so desired.

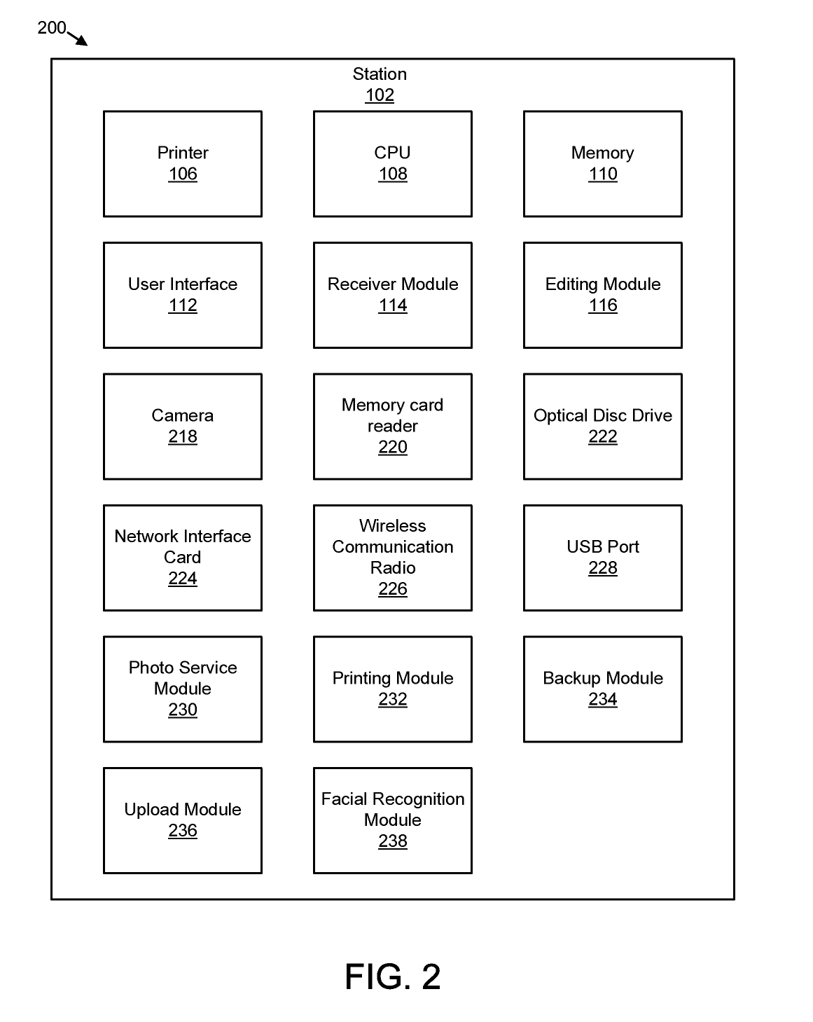

FIG. 2 depicts a schematic block diagram of one embodiment of an apparatus 200 in accordance with the present disclosure. The apparatus 200 includes a station 102 and a background graphic (not pictured), the background graphic being substantially similar to that described in connection with FIG. 1. The station includes a printer 106, a CPU 108, a memory 110, a user interface 112, a receiver module 114, and an editing module 116, which are substantially similar to those described in connection with FIG. 1. The station 102 in the depicted embodiment also includes a camera 218, memory card reader 220, optical disc drive 222, network interface card 224, wireless communication radio 226, USB port 228, photo service module 230, printing module 232, backup module 234, upload module 236, and facial recognition module 238.

The embodiment of the present disclosure depicted in FIG. 2 includes a receiver module 114. The receiver module 114, in the depicted embodiment, works with the camera 218, the memory card reader 220, the optical disc drive 222, the network interface card 224, the wireless communication radio 226, the USB port 228, and/or the photo service module 230 to transfer or provide digital media, including photographs and images, to the station 102. The receiver module 114 is substantially similar to the receiver module 114 described above in connection with FIG. 1.

The station 102, as depicted in FIG. 2, includes a camera 218. The camera 218 may be a digital camera or a film camera. The camera 218 may be a point and shoot, or a single lens reflex (“SLR”). In one embodiment, the camera 218 is built into the station 102. In another embodiment, the camera 218 may be attached to the station using a wire, a cable, a fiber optic connection, a wireless connection, or another type of connection. In a further embodiment, the camera 218 may be separate from the station, and attached via a wired or wireless network connection, a wireless communication protocol such as BLUETOOTH, or another type of connection. In one embodiment, the camera 218 may be used by a resort photographer, cruise photographer, or other professional photographer to take images of guests, activities, scenic vistas, tourist destinations, or the like.

The station 102, in the embodiment shown in FIG. 2, includes a memory card reader 220. The memory card reader 220 may be integrated into a computer device contained within the station 102, or may be external and connected via a cable. In one embodiment, the memory card reader 220 may be attached externally to the station using glue, adhesive, screws, a locking mechanism, or the like. The memory card reader 220 may include capabilities to read memory cards of various types, sizes, brands, or standards, including but not limited to Compact Flash, Extreme Digital (“xD”), Memory Stick, PC Card (“PCMCIA”), Secure Digital (“SD”), microSD, miniSD, or others. The memory card reader 220 may be of the same color as the station, a different color, or partially the same and partially a different color.

The embodiment of the station depicted in FIG. 2 includes an optical disc drive 222. The optical disc drive 222 may read a compact disc (“CD”), a digital versatile disc (“DVD”), an HD disc, a BLU-RAY disc, or one or more other optical media formats. The optical disc drive 222 may be used to read and transfer photographs, images, illustrations, or other digital media from an optical disc to the station 102. The optical disc drive 222 may include read or write capabilities. The station 102 may utilize the write capabilities of the optical disc drive 222 for other features of the station, including but not limited to the backup module 234, which is described in detail below.

The station 102 may also include a network interface card 224. The network interface card 224 may provide a wired or wireless connection to a network. The network interface card 224 may be utilized by various modules within the station, including but not limited to the receiver module 114, the photo service module 230, the printing module 232, the backup module 234, and the upload module 236. The network interface card 224 may be used to communicate with a network enabled camera.

One embodiment of the present disclosure may include a wireless communication radio 226. The wireless communication radio 226 may interface with one or more various communication standards or protocols, including but not limited to BLUETOOTH, near field communication (“NFC”), radio frequency identification (“RFID”), IEEE 802.11, and the like. The wireless communication radio 226 may be used to interface or connect with a network enabled camera, or another device. After connecting, the wireless communication radio 226 may transfer images or other files to or from the connected device via the wireless connection.

The present disclosure, as depicted in FIG. 2, includes a USB port 228. The USB port 228 may be used to connect peripheral devices to the station 102. A peripheral device such as a camera, a scanner, a handwriting input device, a tablet, a smartphone, or other USB enabled device may be connected to the station using the USB port 228.

The embodiment depicted in FIG. 2 includes a photo service module 230. The photo service module 230 allows the station 102 to connect to a photo service, such as but not limited to PICASA, IPHOTO, FLICKR, and the like. The photo service module 230 may also include functionality for connecting and interfacing with a social media service, such as but not limited to FACEBOOK, GOOGLE PLUS, TWITTER, LINKED IN, etc. In an additional embodiment, the photo service module 230 may download digital media such as photos, images, or videos from a connected service. In another embodiment, the photo service module 230 may upload and/or download comments, remarks, or other communications provided by the connected service. For example, the user may view and respond to comments made on the user's FACEBOOK photos, or make additional comments on another user's FACEBOOK photos. In a further embodiment, the photo service module 230 may obtain or share facial recognition information from a photo service or social media service. The photo service module 230 may exchange or share the facial recognition information with the facial recognition module 238.

The station 102 includes a printing module 232. The printing module 232 may communicate with the printer 106 to print digital media, which may include images, which have been manipulated, edited, enhanced, or otherwise altered by the editing module 116. The printing module 232 may print the media onto various media types, including but not limited to paper, photo paper, cardstock, cardboard, canvas, fabric, clothing, plastic, glass, etc. The target media may, in one embodiment, include pre-cut, dye cut, or kiss cut sticker sheets. The sticker sheets may include shapes other than rectangles or squares, but may form any shape. The printing module 232 may include functionality to etch or engrave an image onto the target media.

The printing module 232 may, in some embodiments, provide functionality and an interface for the user to select and print digital media. In another embodiment, the station 102 may include a separate screen and user interface 112 for viewing, selecting, and approving completed projects which are ready for printing. For example, this may be used at a hotel, where the printer 106 is located at the front check-in desk, and the projects will only be printed after the hotel employee selects, approves, and charges the printing fee to the appropriate room. Furthermore, allowing for print jobs to be individually selected or approved may ensure that projects which require a specific medium, paper type, or template will not inadvertently print onto the incorrect medium if it is not loaded into the printer 106.

In another embodiment, the print approval mechanism may include functionality for a user to select, pay, and print without additional intervention, such as by an integrated a credit card reader, cash and coin acceptor, connection to an online payment provider such as PAYPAL, or the like. In a further embodiment, the printing module 232 may accept a payment, redemption, or coupon code to enable printing. For example, in a theme park or gift shop, a user may wish to view photos on the station 102, pay for prints at a cashier, then return and print the photos from the station 102 using a payment code paid for at the cashier counter. In one embodiment, the user may purchase the paper in an individual sheet, or as a printing or project kit. The printing module 232 may prompt the user to insert the appropriate sheet from the kit when printing completed media.

The printing module 232 may include functionality to print digital media in various sizes. The printing module 232 may print the media in standard photo sizes, such as 3″×5″, 4″×6″, 8″×10″, etc. The printing module 232 may also print in non-standard photo sizes, which in one embodiment may be selectable or input by a user. In another embodiment, the printing module 232 prints the media onto stickers. The stickers may be pre-cut, and may be associated with a particular background graphic 104. The printing module 232 may print a scrapbook page, which includes decorative elements, one or more images, and a background. The printing module 232 may print a postcard which includes one or more digital media, edited and sized by the user. The printing module 232 may print a passport booklet with custom user images, or other images preloaded onto the station 102, such as of a resort, cruise ship, or tourist destination.

In another embodiment, the printing module 232 prints stickers to be used to create a personalized board game. The background graphic 104 includes a game board and multiple game pieces. Each game piece includes a sticker with a printed image of a face on it, which may include additional facial features like a moustache, hat, or the like. The face stickers may then be adhered to the game playing pieces, and additionally to the playing board itself. The board game may, in one embodiment, be similar to a scavenger hunt, with the objectives of the game including searching for and discovering different locations, destinations, or objectives to complete.

The station 102 also includes a backup module 234. The backup module 234, in one embodiment, provides the option for the user to copy, transfer, or move digital media files from the station 102 to a backup media. The backup media may be a CD, a DVD, a BLU-RAY, a USB drive, a memory card, or an external hard disk drive. The backup module 234 may copy, move, or otherwise transfer images or other files from a user's memory card inserted into the memory card reader 220, or a camera connected to the USB port 228. In one embodiment, the backup module 234 uses the write capabilities of the optical disc drive 222 to write or burn an optical disc, which may include files, images, or other digital media. In another embodiment, the backup module 234 may copy digital media onto a USB drive. For example, a resort may sell USB drives to guests, who may then backup their camera memory cards onto a USB drive in order to free up space on their memory cards to continue to take photographs for the remainder of their time staying at the resort. The backup module 234, after backing up the files, may erase the entire memory card, only erase files successfully backed up, selectively erase files, or not erase any files.

The station 102 also includes an upload module 236. The upload module 236 allows a user to upload digital media from the station 102 to a web-accessible server, a digital photo sharing service, or a website. The upload module 236 may, in one embodiment, work with the photo service module 230 to connect to a digital photo sharing service. The digital photo sharing service may, in another embodiment, include but not be limited to PICASA, IPHOTO, FLICKR, and the like. The upload module 236, in another embodiment, may connect to a social media service such as, but not limited to, FACEBOOK, GOOGLE PLUS, TWITTER, LINKED IN, etc. In one embodiment, the photo service module 230 may upload digital media such as photos, images, or videos. The upload module 236 may connect to a blogging service, such as but not limited to WORDPRESS or BLOGGER, and provide functionality for connecting, uploading, and posting images, photographs, videos, or other digital media. The upload module 236 may also email one or more digital media or completed projects to one or more selected email addresses.

The station 102 also includes a facial recognition module 238. The facial recognition module 238 may scan or process one or more images of a user. The facial recognition module 238, in one embodiment, builds a facial profile of a user from one or more images of the user. The images may be obtained from any of a number of sources, including a camera, a memory card reader, an optical disc drive, the network interface card 224, a wireless communication radio 226, the USB port 228, connecting to a digital photo sharing service, connecting to a social media service, or the like. The facial recognition module 238 may detect points on a face, the shape of a face, or otherwise use techniques for facial recognition known to those in the art to build the facial profile. The facial recognition module 238, in response to completion of a user's facial profile, may display, print, or otherwise provide to a user additional images of the user based on the user's facial profile.

For example, on a cruise ship, there may be a large number of images taken and added to the station 102 by employees or photographers employed by the cruise ship. There may be hundreds or thousands of images of the hundreds or thousands of cruise passengers. Without facial recognition, a user might be required to view all of the images in order to locate desirable pictures. By using the facial profile, the facial recognition module 238 can, in one embodiment, provide to the user the images taken by the cruise employee in which there is a match of the facial profile. The facial recognition module 238 may, in one embodiment, include security features to only allow the user to view images in which there is a match or potential match of that user's facial profile. In another embodiment, the user can navigate through the shots taken by the cruise employee, so as to be able to access the pictures of family or friends, which may have been taken at close to the same time as the ones of the user identified using the facial profile. After selecting and confirming desired images, the user may use the images to create postcards, photo prints, activity projects, or in any other feature of the station 102.

The facial recognition module 238, in one embodiment, may improve the created facial profile as the user confirms or denies suggested matches of the user's face. The images matched and identified using the facial recognition module 238 may, in one embodiment, be available for the user to use in the same manner as all the other user's images, including printing, downloading, uploading, etc. The images identified using the facial recognition module 238 may, according to one embodiment, be used by or in connection with any of the other modules of the apparatus 200.

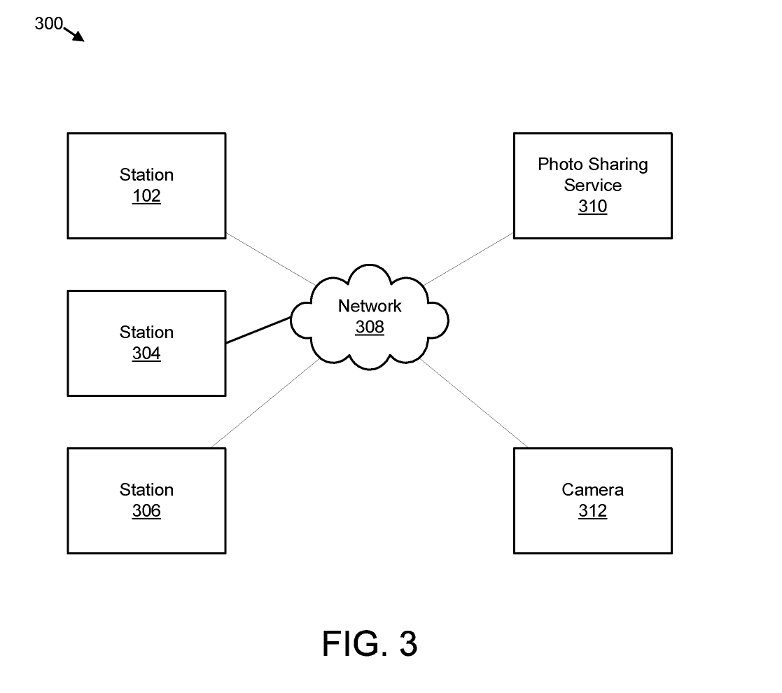

FIG. 3 is a schematic block diagram of an alternate embodiment of an apparatus in accordance with the present disclosure. The apparatus 300 includes a station 102, additional stations 304, 306, a network 308, a photo sharing service 310, and a network enabled camera 312.

The station 102 is substantially similar to the station described above in connection with FIG. 2. The additional stations 304, 306 may, in one embodiment, each also be substantially similar to the first station 102. In another embodiment, each additional station 304, 306 may include different, more, or fewer modules, hardware, and/or features than the first station 102. The additional station 304, 306 may be a tablet, a laptop, a smartphone, or a television. The additional station 304, 306 on a tablet or television may include an app with similar modules or elements to the first station 102. For example, in a hotel with the apparatus 300, the first station 102 could be located at the front check-in desk, with an additional station 304 on the television in each hotel room. Hotel guests could view and order photo prints from their hotel rooms, to be printed and picked up at the first station 102 located at the front desk. Similarly, in another embodiment, a hotel could include a link for ordering photo prints from an additional station 304, embodied in a website linked to from the hotel website. The hotel website with the corresponding link may be displayed when a guest initially connects to the hotel internet connection. In another example, a station 304, 306 on a tablet may be used at a cruise ship activity center, where each activity center participant works to create crafts, taking turns using the tablet to create and print personalized photographic media for use in the craft projects.

The apparatus 300 includes a network 308. The network 308 may be an intranet, or a connection to the worldwide web. The network 308 may include wired or wireless connections. Some of the devices connected to the network 308 may be wired, and some may be wireless. The network 308 is similar to networks known in the art.

The apparatus 300 includes a photo sharing service 310. The photo sharing service 310 may, in one embodiment, include but not be limited to PICASA, IPHOTO, FLICKR, and the like. The photo sharing service 310 may also include, in another embodiment, a social media service such as, but not limited to, FACEBOOK, GOOGLE PLUS, TWITTER, LINKED IN, etc. The photo sharing service 310 is connected to over the network 308 by the photo service module 230 or the upload module 236.

The apparatus 300 includes a network enabled camera 312. The network enabled camera 312 can transmit images taken by it or another camera over a network connection, which are then received by any of the stations 102, 304, 306. For example, on a cruise ship, multiple professional photographers could be employed, each using a network enabled camera 312. The images taken using the network enabled camera 312 would be automatically transmitted to the first station 102, and viewable on each additional station 304, 306 for any cruise guest to use in an activity project created with one of the stations 102, 304, 306.

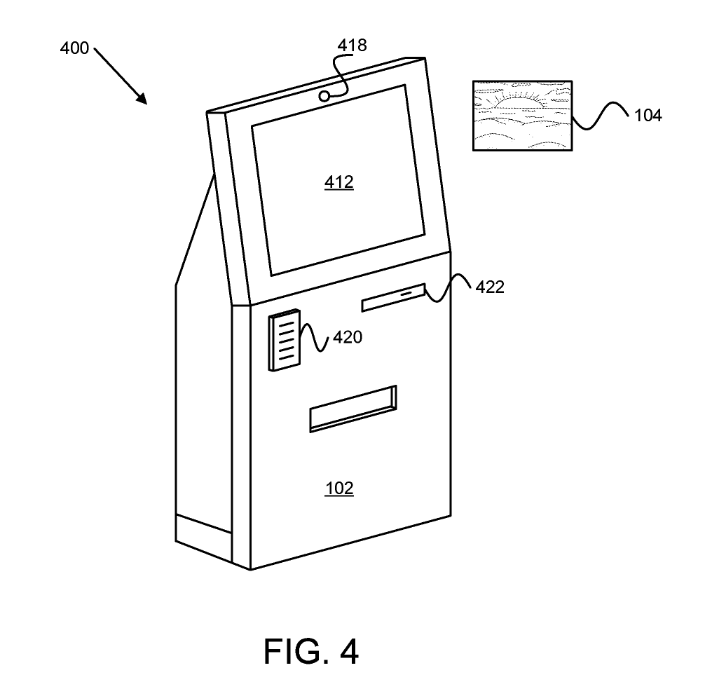

FIG. 4 is a schematic diagram of an alternate embodiment of an apparatus in accordance with the present disclosure. The apparatus 400 includes a station 102 and a background graphic 104. The station includes a CPU (not shown), a memory (not shown), a user interface 412, a printer (not shown), which are substantially similar to those described in relation to FIG. 2. The station further includes a camera 418, a memory card reader 420, an optical disc drive 422, a network card interface (not shown), and a wireless communication radio (not shown).

In the embodiment depicted in FIG. 4, the station 102 includes a kiosk. The kiosk could be placed in a hotel lobby, on a cruise ship, in the visitor's center of a popular tourist destination, or any other location. The kiosk includes a camera 418, which can be used to take images of the user at the station. The images taken with the camera 418 could be used to print media using the station.

The kiosk, in one embodiment, is formed from molded plastic. The kiosk may, in another embodiment, have a sturdy, heavy duty, or industrial look. The kiosk may include decorative designs, advertising, text, logos, or the like.

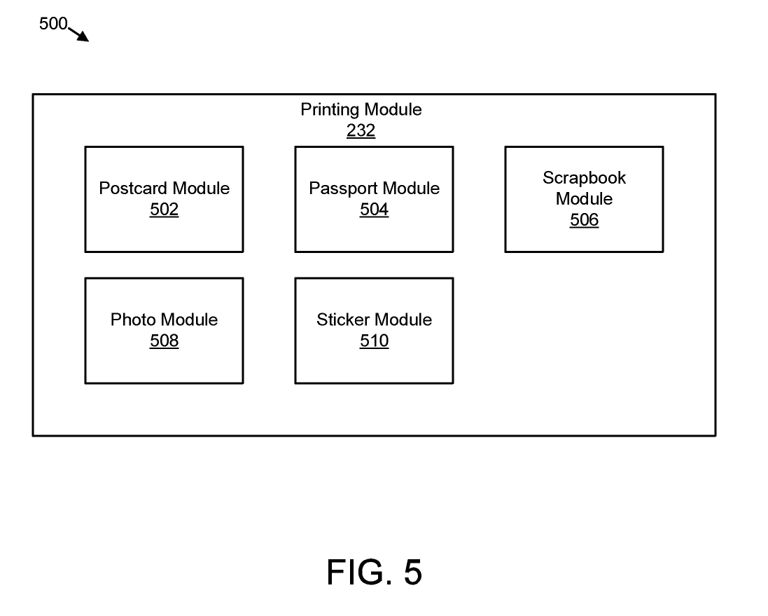

FIG. 5 is a schematic block diagram of one embodiment of a printing module in accordance with the present disclosure. The printing module 232 includes a postcard module 502, a passport module 504, a scrapbook module 506, a photo module 508, and a sticker module 510. The printing module 232 is substantially similar to that described above in connection with FIG. 2.

The printing module 232 includes a postcard module 502. The postcard module 502 is configured to size, design, and print one or more digital media onto a postcard. The postcard, in one embodiment, may be a standard size, such as a 4″×6″ or 5″×7″. The postcard, in another embodiment, may be pre-printed on one side. The pre-printed side may, in various embodiments, include a space for writing a message, a space for postage, a photo or image, or the like. The photo or image, in one embodiment, may be of a resort, cruise ship, tourist destination, landscape, or other image.

The postcard module 502, in a further embodiment, may arrange, shape, and size multiple user images to create another image. The image, in one embodiment, is formed from the combination of the user images. The postcard module 502, in another embodiment, uses multiple images each formed into an individual shape and placed in a different pattern, where the pattern corresponds to the postcard to be printed. The images are each scaled, then framed and laid out on the postcard to become the image to be printed.

In another embodiment, the postcard module 502 creates a collage of images selected by the user. The user may mix and match their own photos, photos identified using the facial recognition module 238, or other stock photos pre-loaded onto the kiosk. Pre-loaded photos may, in one embodiment, be of a resort, a cruise ship, a tourist destination, or the like.

The postcard module 502, in one embodiment, includes functionality for preprinting postage onto one side of the postcard. The postage print functionality may be for one country, such as the United States through the United States Postal Service, or for multiple different countries. The postcard module 502 may further include functionality for selecting and using a custom image for the printed postage.

The printing module 232 includes a passport module 504. The passport module 504 may be configured to print a booklet resembling a passport. For example, a station 102 located on a cruise ship may print a passport with graphics, images, and designs based on the cruise ship. The user may print a passport booklet with the user's photo. The passport booklet may then be used throughout the duration of the cruise to exchange information, stickers, or other media with other cruise ship guests. The cruise ship may provide “check-in” destinations for the duration of the trip, including various ship restaurants and activities, as well as the day trips available at each of the ports on the cruise. The user may use the passport to create a personalized record of the people and places from the cruise, providing a memorable, personalized souvenir and record of the time on the cruise ship.

The printing module 232 includes a scrapbook module 506. The scrapbook module 506 prints a detailed photographic page with decorative elements. The scrapbook module 506 prompts the user to select a layout and project for a particular scrapbook page. The scrapbook module 506 then prompts the user to select one or more images, the number determined by the number of images required by the project selected. After selecting an image, the scrapbook module 506 prompts the user to size, shape, and position the one or more images to fit within the template of the selected project. The project may include various images, backgrounds, foregrounds, masks, and the like. After completing the scrapbook page, the page is printed.

The printing module 232 includes a photo module 508. The photo module 508 provides the functionality of a traditional photo print station to the user. The user can select, size, and crop one or more images for printing in standard photo sizes. The photo module, in one embodiment, may print images in 2.5″×3.5″ (“wallet size”), 3″×5″, 4″×6″, 5″×7″, 8″×10″, or other sizes. The photo module 508 may print glossy, semi-gloss, or matte finish prints.

The printing module 232 includes a sticker module 510. The sticker module is configured to print multiple images on a single sheet, the single sheet being formed of a base sheet layer and an imaging sheet layer which are removably adhered together, wherein each of the multiple images are separately sized, shaped, and cut, and furthermore can be separately peeled off from the supporting base sheet layer. The sticker module may print one or more copies of one image on multiple stickers, or in another embodiment may print one or more copies of different images on multiple stickers.

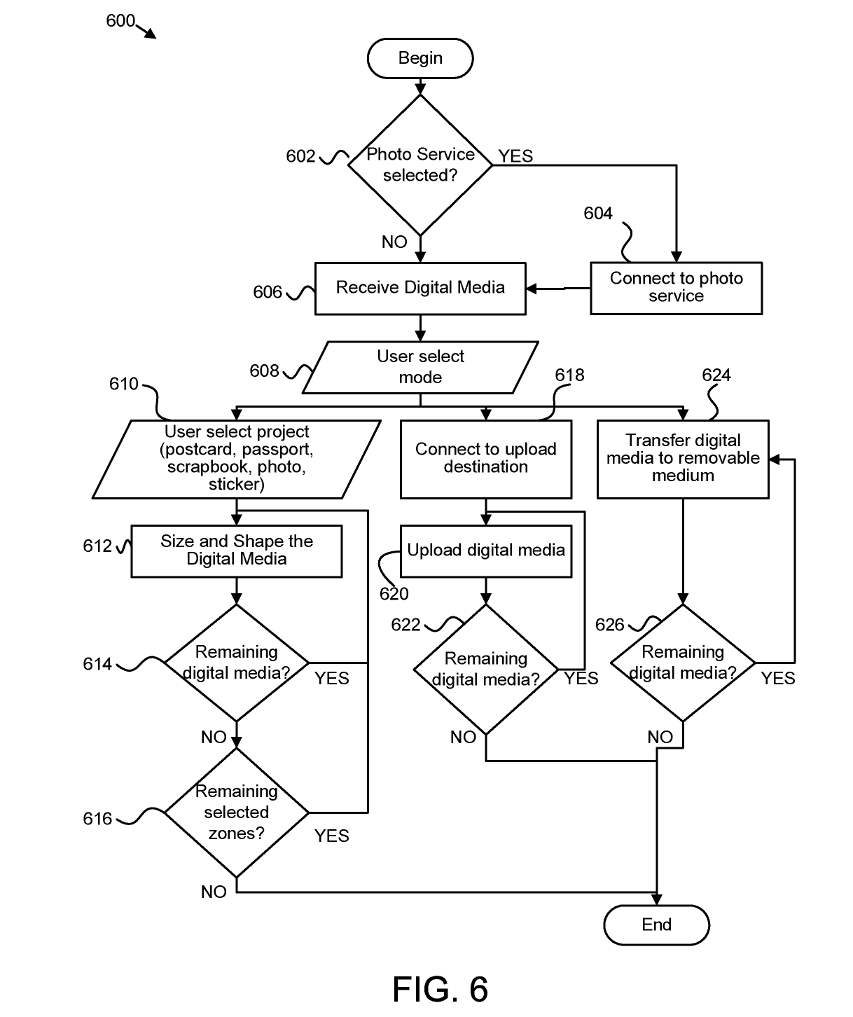

FIG. 6 is a schematic block diagram of a flowchart depicting one embodiment of a method of the present disclosure. The method 600 begins. The user, in one embodiment, selects 602 whether or not to retrieve digital media, such as images, from a photo service. The photo service could be accessed, in one embodiment, by the photo service module 230. If using a photo service from which to retrieve digital media, the photo service module 230 connects 604 to the photo service. After connecting, the station 102 receives 606 the digital media. In an embodiment in which there is not a photo service option, or if the user decides not to use a photo service, the receiver module 114 receives 606 digital media from another source, such as a digital camera, a memory card, an optical disc, or the like. The receiver module 114 may receive one or more digital media.

The user then selects 608 the mode in which to operate the station 102. If when selecting 608 the mode, the user selects to create a project, the user then selects 610 a type of project. In one embodiment, project options could be include a postcard, a passport, a scrapbook page, a photo, or a project including one or more stickers. The editing module 116 then sizes and shapes 612 the digital media. Once completed, if there are remaining 614 digital media, the editing module 116 continues to size and shape the digital media until all the digital media have been sized and shaped. In one embodiment, the background graphic 104 may include multiple selected zones. If there are remaining 616 selected zones, the editing module 116 sizes and shapes additional digital media. If there are not remaining 616 selected zones, the method ends.

If when selecting 608 the mode, the user selects to upload digital media, the upload module 236 connects 618 to the upload destination. The upload destination may include a web accessible server, a digital photo sharing service, or a website. After connecting, the upload module 236 uploads 620 the digital media to the upload destination. The upload module 236 may upload one or more digital media. After completing uploading a digital media, if there are remaining 622 digital media, the upload 620 continues. If there are not digital media remaining 622, the method ends.

If when selecting 608 the mode, the user selects to backup digital media, the backup module 234 may, in one embodiment, prompt the user to select a particular removable medium. A removable medium, in various embodiments, could include a CD, a DVD, a BLU-RAY, a USB drive, a memory card, an external hard disk drive, or the like. After the user selects at least one removable medium to use for backup, the backup module 234 transfers 624 digital media to the removable medium. In transferring digital media to the removable medium, the backup module 234 could copy, duplicate, or move the digital media from the station 102 to the removable medium. While there are remaining 626 digital media, the backup module 234 continues to transfer digital media to the removable medium. If there are not remaining 626 digital media, the method ends.

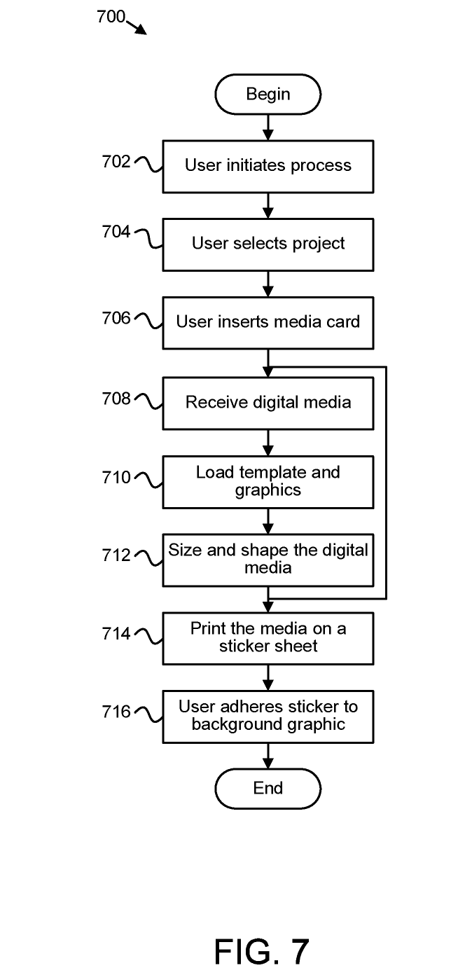

FIG. 7 is a schematic block diagram of a flowchart depicting one embodiment of a method by which a user creates a personalized sticker photo craft project using the present disclosure. The method 600 begins, and the user initiates 702 the process.

The user then selects 704 a project. In the embodiment of the method depicted in FIG. 7, the user selects to create a personalized craft project. In alternative embodiments, the user's selection of a project could be to print photos, print a postcard, print a passport, print a scrapbook page, print photos, print stickers, backup photos, upload photos, view photos, identify photos, or any other feature included in the particular station 102. Certain projects may require making additional selections in relation to the particular project. For example, if the user selected to print a postcard, the user would then select which design, and template to use. Each other potential selection may have its own possible additional options, which are unique to each type of project available. In FIG. 7, where the user selects to create a personalized craft project, the user also selects which type of project, which design, the setting, and the size.

The user then inserts 706 a media card. In the particular embodiment depicted in FIG. 7, user images are loaded from a memory card. In an alternative embodiment, images may be loaded from a camera, an optical disc, a network connection, a wirelessly connected device, a device connected via USB, an online photo service, or selected from photos already loaded on the station 102.

After the station 102 receives 708 digital media selected by the user, the station 102 loads 710 the template and graphics into the memory 110. Each project selected may include various graphics, images, masks, and other configuration files necessary to that particular project. For example, in a craft activity project, the configuration files in one embodiment may include one or more coordinate files with coordinates for placing each image within each mask when designing that particular craft project.

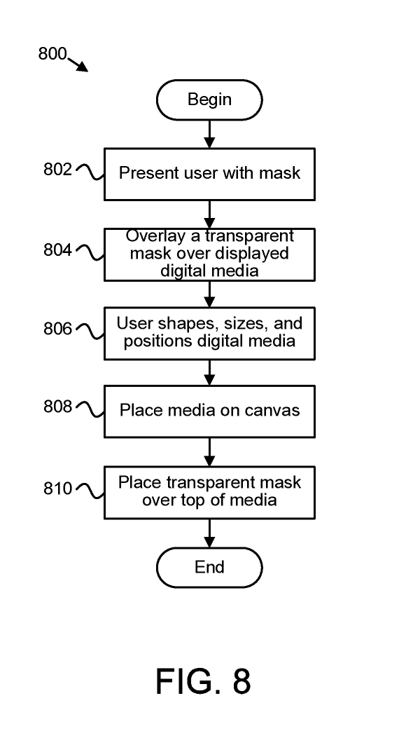

The user then sizes and shapes 712 the digital media to fit within the selected template for the selected project. The user interface 112 may, in one embodiment, provide controls for positioning, sizing, shaping, cropping, adjusting the orientation, or otherwise altering the selected image. Other controls for editing, adjusting, and manipulation known in the art of digital photography and design may be included. More details about the steps of sizing and shaping 712 the digital media, according to one embodiment, are included in FIG. 8 below.

The station 102 then checks if the required number of images for the selected project has been added. If the required number of images has not been added, then the method returns and receives 708 digital media. If the required number of images has been added, the print module 232 prints 714 the media on a sticker sheet. Depending on the project selected 704, there may be one or more sticker sheets. The sticker sheets, in one embodiment, are precut, and the images are printed in the appropriate position on the page so as to be easily peeled off and removed by the user. In an alternative embodiment, if the user were creating a different project, the print module 232 may print a different project.

After printing, the user adheres 716 the sticker to the background graphic. The background graphic contains a selected zone sized and shaped to fit the media, and the user attaches the media to the selected zone. The method 700 then ends.

FIG. 8 is a schematic block diagram of a flowchart depicting one embodiment of the step of sizing and shaping the digital media. There are many approaches, methods, or ways in which to size and shape the digital media, but FIG. 8 depicts just one way to do so. In one embodiment, the detailed steps depicted in FIG. 8 may be similar to the single step of sizing and shaping 712 the digital media included in FIG. 7.

The method 800 begins, and the user has already selected a project, the receiver module has received an image, and the template and associated files have been loaded. The editing module 116 presents 802 the user with a mask. The mask may be one of several masks associated with the selected project. The mask may be aligned for display, in one embodiment, according to a set of coordinates included in a project configuration file. The file may, in one embodiment, be an XML file.

The editing module 116 overlays 804 a transparent mask over the displayed digital media. The project images contain transparent portions, allowing the user selected digital media to show through in the transparent areas. The user then shapes, sizes, and positions 806 digital media to look proper inside the mask. For example, the user may wish to reposition the image to more clearly see a face, group of people, or piece of scenery in the selected digital media. By positioning the digital media within the mask, portions of the media will no longer be visible, resulting in a shape which may form a part of the project.

The editing module 116 places 808 the media on a canvas. The editing module 116 places 810 a transparent mask over top of the media. In one embodiment, the user will be able to continue to see the placement of the completed media and mask while working on other masks and images for the selected project. In another embodiment, each mask for the project is displayed by itself, and the user cannot see past images or masks while working on additional images or masks. By placing the image onto a canvas and then placing a transparent mask over it, in one embodiment, there is no overlap going from one image to the next. In one embodiment, only the final canvas with each individual mask, sized and positioned digital media, and other masks will be printed, resulting in increased performance while printing, uploading, or otherwise saving the completed project. After placing 810 the transparent mask over the top of the media, the method 800 then ends. The method may then continue with the next step of receiving another image or printing the finished product.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An apparatus comprising:
a station comprising a printer, a processor, a memory, and a user interface; wherein the processor and computer memory store code comprising:
a receiver module configured to receive digital media; and
an editing module configured to size and shape the digital media to fit in a selected zone on a background graphic, the background graphic with a selected zone sized and shaped to fit the media such that the user can attach the media to the selected zone.

2. The apparatus of claim 1, the station further comprising an integrated camera.

3. The apparatus of claim 1, further comprising a network enabled camera in communication with the station, the network enabled camera configured to upload digital media to the station.

4. The apparatus of claim 1, the station further comprising a photo service module configured to connect to and retrieve digital media from a digital photo sharing service.

5. The apparatus of claim 1, the background graphic further comprising a companion project with one or more of additional background graphics, and additional removably adhesive media.

6. The apparatus of claim 1, the background graphic further comprising multiple selected zones, each zone sized and shaped to fit a media such that the user can attach the media to the selected zone.

7. The apparatus of claim 1, the editing module configured to size and shape multiple digital media, each digital media sized and shaped to fit in a unique selected zone on a background graphic.

8. The apparatus of claim 1, the station further comprising a printing module.

9. The apparatus of claim 8, the printing module comprising a postcard module configured to size, design, and print one or more digital media onto a postcard.

10. The apparatus of claim 8, the printing module comprising a passport module configured to print a booklet comprising one or more digital media, where the booklet comprises pre-printed pages for at least one of exchanging information, and checking in at one or more destinations.

11. The apparatus of claim 8, the printing module comprising a scrapbook module configured to print a detailed photographic page comprising decorative elements, the photographic page suitable for one or more of displaying and archiving images.

12. The apparatus of claim 8, the printing module comprising a photo module configured to print photographs of various sizes.

13. The apparatus of claim 8, the printing module comprising a sticker module configured to print multiple images on a single sheet, the single sheet being formed of a base sheet layer and an imaging sheet layer which are removably adhered together, wherein each of the multiple images are separately sized, shaped, and cut, and furthermore can be separately peeled off from the supporting base sheet layer.

14. The apparatus of claim 1, the station further comprising an upload module configured to connect and upload digital media to one or more of a web-accessible server, a digital photo sharing service, and a website.

15. The apparatus of claim 1, the station further comprising a facial recognition module configured to display digital media to the user in response to performing facial recognition of an image of the user.

16. The apparatus of claim 15, wherein the facial recognition module only displays digital media which include the user in response to performing facial recognition of an image of the user.

17. The apparatus of claim 1, wherein the station comprises one of a tablet, a laptop, a smartphone, and a television.

18. The apparatus of claim 1, further comprising one or more additional stations electronically connected such that each station is in communication with the first station, each additional station comprising instructions for:
viewing digital media stored on the first station;
transmitting digital media to the first station; and
ordering digital media to be printed at the first station.

19. A method comprising:
receiving digital media; and
sizing and shaping the digital media to fit in a selected zone on a background graphic, the background graphic having a selected zone sized and shaped to fit the media such that the user can attach the media to the selected zone.

20. The method of claim 19, wherein the step of sizing and shaping the digital media to fit in a selected zone on a background graphic comprises the steps of: presenting the user with a mask;
overlaying a transparent mask over the displayed digital media; sizing, shaping, and positioning the media;
placing the media on a canvas; and
placing a transparent mask over a top of the media.
